(19) United States
(12) Patent Application Publication
(10) Pub. No.: US 2015/0199781 A1
(43) Pub. Date: Jul. 16, 2015

(54) Patent Valuation System

(71) Applicant: Wisdomain Inc., Seongnam-si (KR)

(72) Inventors: ILSOO Kim, San Jose, CA (US); Seungho Jung, Anyang-si (KR)

(21) Appl. No.: 14/594,616

(22) Filed: Jan. 12, 2015

Related U.S. Application Data
(60) Provisional application No. 61/927,461, filed on Jan. 14, 2014.
(60) Provisional application No. 61/943,962, filed on Feb. 24, 2014.

(51) Int. Cl. G06Q 50/18; G06Q 10/00

(52) U.S. Cl. CPC G06Q 50/184; G06Q 10/00

(57) ABSTRACT

Methods and systems for valuation of patents assets. Information identifying a target patent asset is received from a client device. A technology sector associated with the target patent asset is determined. A profit for the technology sector is determined. A patent contribution metric is determined corresponding to a contribution of patent assets to business in the technology sector. A price for the target patent asset is determined based on the profit for the technology sector and the patent contribution metric. A patent information output is generated for the client device based on the price for the target patent asset.

### CROSS REFERENCE TO RELATED APPLICATION

This application claims priority from U.S. Provisional Patent Application No. 61/927,461, titled “Patent Valuation System” and filed on Jan. 14, 2014, the contents of which are incorporated by reference in its entirety. This application also claims priority from U.S. Provisional Patent Application No. 61/943,962, titled “Patent Valuation System” and filed on Feb. 24, 2014, the contents of which are incorporated by reference in its entirety.

### BACKGROUND

1. Field of the Disclosure

This disclosure pertains in general to systems and methods for reporting on patent valuation.

2. Description of the Related Art

The valuation of intellectual property (IP) is important when pertaining to trade of IP or for accountants valuating IP as intangible assets, etc.

Though there are some known intellectual property valuation methods such as the cost-approach method, market-approach method, income-approach method, etc., it is a technical challenge to apply those methods to properly valuate intellectual properties, because the unbiased input data for those methods may not be easily acquired. Consequently the valuations of the same intellectual properties can differ depending on the valuating persons, even though they used the same valuation method.

### SUMMARY

Embodiments of the present disclosure relate to valuation of patent asset using unbiased data that produces an objective valuation. In one embodiment, a system for patent valuation is disclosed. The system can include a patent database storing patent asset information about various patents, a company database storing information for various companies, and a patent score database storing patent scores for various patents. The system can include a processor and a non-transitory computer that is executed by the processor for performing a computer implemented method comprising determining, from a client device, information identifying a target patent asset, determining a profit for a technology sector associated with the target patent asset, determining a patent contribution metric corresponding to a contribution of patent assets to business in the technology sector, determining a price for the target patent asset based on the profit for the technology sector and the patent contribution metric, and generating a patent price information output for the client device based on the price for the target patent asset.

In one embodiment, the method further comprises determining an effective period for the target patent asset, the effective period corresponding to a period of time during which the target patent asset has value, wherein determining the profit for the technology sector comprises determining the profit for the technology sector associated with the target patent asset in the effective period. In one embodiment, the effective period is determined based on backwards citations to at least one or more patent assets in the technology sector associated with the target patent asset.

In one embodiment, determining the profit for the technology sector comprises querying the patent database for patent assets in the technology sector and determining the profit for the technology sector based on the patent assets in the technology sector.

In one embodiment, the patent contribution metric can be determined from the research and development expenses in the technology sector and the operating expenses in the technology sector, such as a ratio of the research and development expenses to the operating expenses. In another embodiment, the patent contribution metric can be determined from research and development expenses and operating expenses of at least one company, where the company is associated with the technology sector.

In another embodiment the patent contribution metric can be determined from a number of employees associated with the technology sector and the number of inventors for patent assets associated with the technology sector, such as a ratio of number of inventors to number of employees. In another embodiment, the patent contribution metric can be determined from a number of employees of at least one company and a number of inventors of patent assets of at least one company, where the company is associated with the technology sector. The number of employees and inventors can be determined for a single company or for multiple companies in the technology sector.

In one embodiment, the method further comprises determining a profit attributed to the patent assets based on the profit for the technology sector and the patent contribution metric; determining a profits per patent score (PPPS) based on the patent assets in the technology sector; determining a profits per patent score (PPPS) based on patent scores of the patent assets in the technology sector and the profit attributed to the patent assets, the patent scores indicative of ratings of the patent assets; and determining profit attributed to the target patent asset based on a patent score of the target patent asset and the PPPS, wherein the price for the target patent asset is determined based on the profit attributed to the target patent asset.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a patent valuation system for estimating the price of patent assets, according to one embodiment.

FIG. 2 illustrates a conceptual view of computing the price of a target patent asset, according to an embodiment.

FIG. 3 is a detailed view of the price estimation module from FIG. 1, according to an embodiment.

FIG. 4 illustrates an effective period of a patent asset, according to an embodiment.

FIG. 5 illustrates an example of computing a profit attributed to a patent for a single year, according to an embodiment.

FIG. 5A illustrates a price report generated by the price information module and displayed at the client, according to an embodiment.

FIG. 6 is a flowchart of a patent price estimation process performed by the price estimation module of FIG. 1, according to an embodiment.

FIG. 7A is a flowchart for a method for estimating market sizes of a technology sector, according to one embodiment.

FIG. 7B is a flowchart for the step of estimating a financial metric of a technology sector from FIG. 7A in greater detail, according to an embodiment.

FIG. 7C illustrates a technique for estimating revenue of a company in a technology sector when the total revenue of the company is known, according to an embodiment.

FIG. 7D illustrates a technique for estimating revenue per patent using patent office classifications, according to an embodiment.

FIG. 7E illustrates a technique for estimating a revenue of a company in a technology sector using revenue per patent that is pre-calculated based on patent office classifications, according to an embodiment.

FIG. 8 illustrates the hardware architecture of a patent price estimation system or client, according to one embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures and accompanying description depict various embodiments for purposes of illustration only. One skilled in the art will readily recognize from the following description that alternative embodiments of the structures and methods illustrated herein may be employed without departing from the principles described herein. As used herein, the terms “estimating” “determining” or “computing” may be used interchangeably with each other.

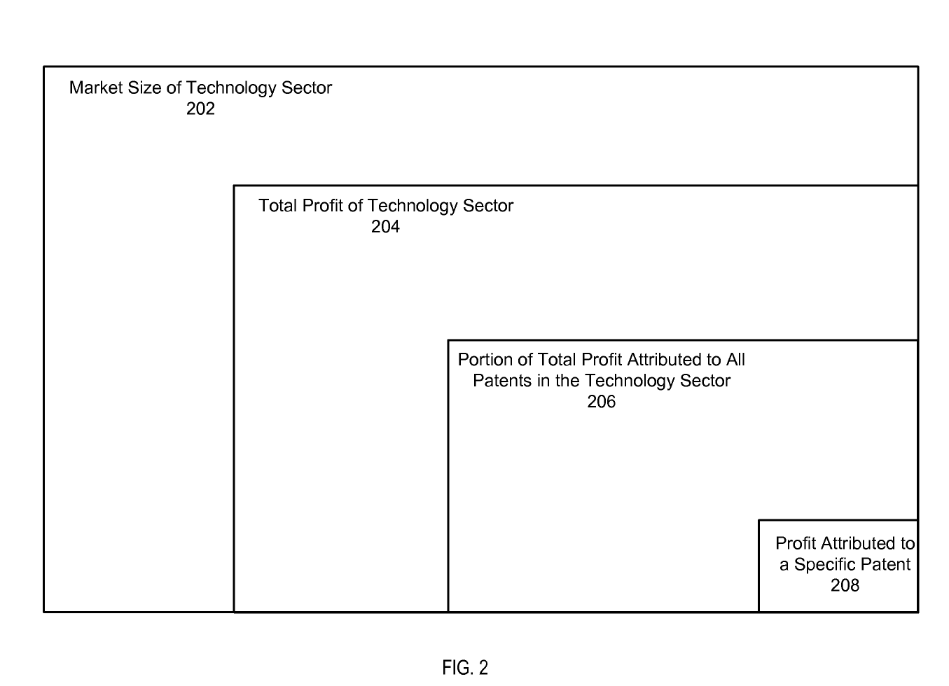

Embodiments of the present disclosure include a patent valuation system that values patent assets based on unbiased data that produces objective valuations. FIG. 2 illustrates a conceptual view of computing the price of a patent asset, according to an embodiment. The large box 202 represents the market size of a technology sector in a specific year, which is determined from the total revenue in the technology sector. The next box 204 represents the total profit of the technology sector, which is smaller than the market size. The next box 206 represents the portion of the total profit attributed to all patent assets in the technology sector. The smallest box 208 represents the profit attributed to a specific patent asset in the technology sector.

Embodiments of the present disclosure determine the total profit 204 in a technology sector, then determine a portion of the total profit 206 attributed to all patents in the technology sector, and then determine the profit 208 attributed to a specific patent asset in the target technology sector. The price of a patent asset corresponds to the profit attributed to a patent asset while the patent asset is effective. Each step is performed with unbiased data, which can include for example, market size trends and profitability, contribution ratio of patents to business, patent strength, and patent lifecycles, which produces an objective patent asset valuation

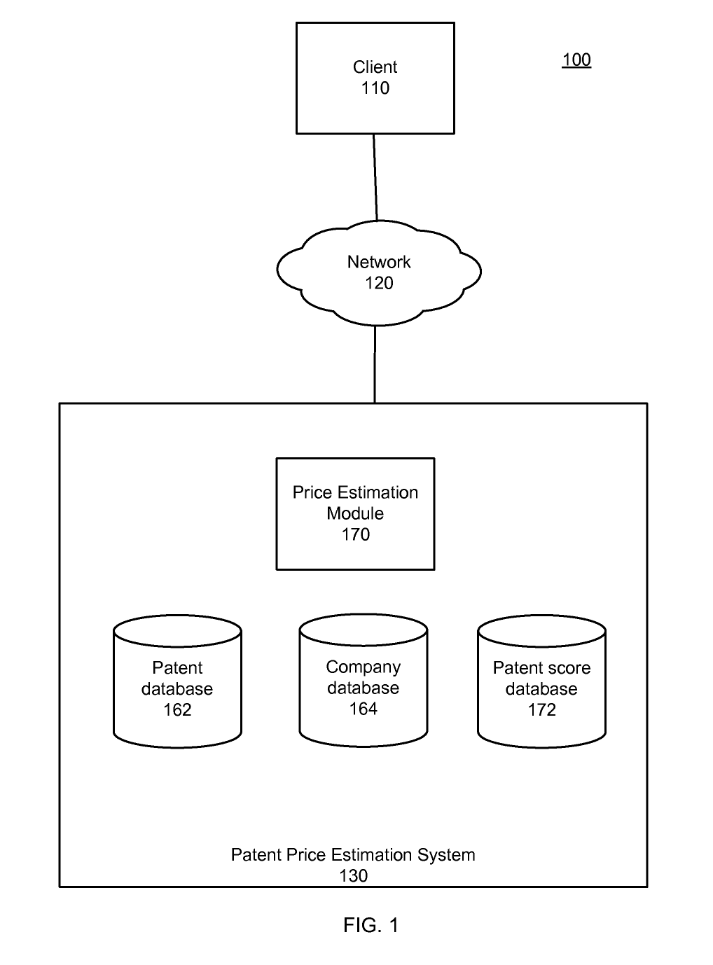

FIG. 1 is a high-level block diagram of a patent valuation system 100 for estimating the price of patent assets, according to one embodiment. The patent valuation system 100 includes a client 110 and a patent price estimation system 130 connected to a network 120. Only one client 110 is shown in FIG. 1 to simplify and clarify the description. Other embodiments of the computing environment 100 can have multiple of clients 110 communicating with the patent price estimation system 130 via the network 120.

The network 120 represents the communication pathways between the client 110 and patent price estimation system 130. In one embodiment, the network 120 can be an internal network or the Internet. In one embodiment, the network 120 uses standard communications technologies and/or protocols. Thus, the network 120 can include links using technologies such as Ethernet, 802.11, integrated services digital network (ISDN), digital subscriber line (DSL), asynchronous transfer mode (ATM), etc. Similarly, the networking protocols used on the network 120 can include the transmission control protocol/Internet protocol (TCP/IP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, a client 110 is a computing device, such as a desktop computer, laptop computer, tablet computer, smartphone, etc. The client 110 executes a web browser, such as GOOGLE CHROME, or other software program that allows a user to make patent price requests for one or more patent assets from the patent price estimation system 130, and to receive and display patent price information received from the patent price estimation system 130.

The patent price estimation system 130 estimates the price of one or more target patent assets based on requests from the client 110 and sends a patent price information output for the target patent assets to the client 110. In one embodiment, the patent price estimation system 130 is one or more server class computers or other computing devices. As shown, the patent price estimation system 130 includes a price estimation module 170, a patent database 162, a company database 164 and a patent score database 172.

The patent database 162 includes a large collection of patent assets. Patent assets include granted patents, patent publications, or both granted patents and patent publications. The patent assets may include United States (U.S.) patent assets, patent assets from other countries, regional patent assets (e.g., European Patent Office) and/or international patent assets (e.g., Patent Cooperation Treaty). The patent database 162 also maintains information for the patent assets, such as specifications, claims, publication number, title, inventors, assignee information or applicant information specifying a company that owns the patent, the year of filing, the year of publication, the patent office classification (e.g., US patent classification, international patent classification), and other pertinent information that is typically printed on the face of a patent asset. The information may also include expiration status information (e.g. maintenance fee payments) for the patent assets and termination status information describing whether the patent assets have been terminated for any reason (e.g. abandonment).

The company database 164 stores information about a large number of companies. Companies may include any legal entity, such as partnerships, corporations, etc. The information can include number of employees, a discount rate, and financial information for the companies. The information can be divided across countries and by time (e.g. year by year). The information may be retrieved from publicly available sources of corporate information, such as yearly 10-K statements filed with the Securities and Exchange Commission (SEC).

The financial information includes financial metrics, which are a quantitative statistics providing an assessment of financial performance. In one embodiment the financial metrics are profit/net income. Other types of financial metrics are research and development (R&D) spending, revenue, etc. For some companies, the company database 164 may include exact financial metrics for the company that are divided into different technology sectors. However, for most companies the company database 164 only has generic financial metrics for the company as a whole that are not specific to any particular technology sector.

The patent score database 172 includes patent scores for patent assets that represent the objective rating of a patent asset. Patent scores can be numerical (e.g., between 1-100) where higher patent scores indicate that a patent asset has a higher rating. A higher rating means the patent is more important in the technology sector or is of a higher quality. Patent scores may also be referred to as patent grades. There are many methods to generate the patent scores. For example, patent scores can be generated from inventors' expertise, technological significance, technological endurance, marketability, technological focus and novelty, assignee's endeavors for ownership of technology and degree of competitors' containment.

Inventors expertise is determined for an inventor from number of patent assets filed by the inventor, number of granted patents to the inventor, percentage of granted patents against applications, number of patent families, number of citations, number of claims, duration of pending period for the inventors patents, number of continuations filed by inventor and period of remaining validity for the inventors patents. Technological significance is determined from number of forward citations of the patent asset. Technological endurance is determined from average interval between filing date of the patent asset and those of citing patent assets. Marketability is determined from number of patent assets in the family. Technological focus is determined from number of genealogy patent assets (division, cons, CIP). Novelty is determined from number of direct backward citations, where fewer backward citations equals greater novelty. Assignee's endeavors for ownership of technology is determined from patent prosecution activities, such as early action requests, re-exam requests, etc.

The price estimation module 170 receives a price request from the client 110 requesting a price of one or more target patent assets. The price estimation module 170 determines a target technology sector for the patent asset and determines a price for the target patent asset within the target technology sector. The price represents the estimated monetary value of the target patent asset within the technology sector, and provides an estimate of the amount of money that should be paid for the target patent asset if it is sold. The price estimation module 170 then generates and transmits a patent price information output for the target patent asset to the client 110.

The price estimation module 170 generates the price for the target patent asset from information obtained from or determined from the databases 162, 164 and 172. The information can include the overall profit for the technology sector, inventors in the technology sector, employees in the technology sector, patent scores and other criteria that will be described herein. Because these datapoints are relatively unbiased, it produces a valuation for a patent asset that is objective and can be trusted.

FIG. 2 illustrates a conceptual view of computing the price of a target patent asset, according to an embodiment. The large box 202 represents the market size of a technology sector in a specific year, which is determined from the total revenue in the technology sector. The next box 204 represents the total profit of the technology sector, which is smaller than the market size. The next box 206 represents the portion of the total profit attributed to all patents in the technology sector. The smallest box 208 represents the profit attributed to a specific patent 208 in the technology sector.

Embodiments of the present disclosure determine the total profit 204 in a target technology sector, then determine a portion of the total profit 206 attributed to all patents in the target technology sector, and then determine the profit 208 attributed to a target patent asset in the target technology sector. The process can be repeated over a series of years to determine the yearly profit attributed to the target patent asset over a series of years, which are then combined to produce a price or value of the target patent asset.

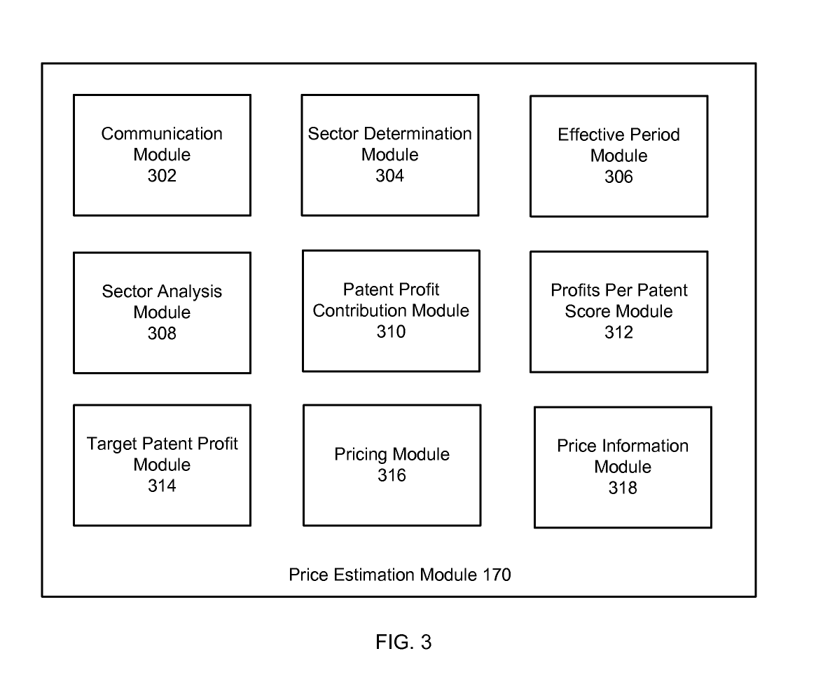

FIG. 3 is a detailed view of the price estimation module 170 from FIG. 1, according to an embodiment. As shown, the price estimation module 170 includes a communication module 302, a sector determination module 304, an effective period module 306, a sector analysis module 308, a patent profit contribution module 310, a profits per patent score module 312, a target patent profit module 314, a pricing module 316, and a price information module 318.

The communication module 302 communicates with the client 110 to receive a price request from the client 110 requesting a price of a target patent asset and to transmit price information to the client 110 once the price information is determined. The price request includes information identifying one or more patent asset numbers for pricing. For example, the price request can include issued patent numbers or patent application numbers. The request can also include an identification of a specific technology sector that the target patent asset is in. A technology sector can include any area of technology. For example, the technology sector may be a broad technology sector such as “software” or a narrower technology sector such as “wireless speakers.” A myriad of possible technology sectors may be requested by the client 110 and are not limited to these specific examples.

In some embodiments, the request may be directly input to the communication module 302 through a user input device (e.g., keyboard) of the market estimation system 130 without using a client 110. In other embodiments, the request may be received from a computer program within the patent valuation system 130. In one embodiment, the client communication module 302 may communicate with the client 110 or other computer programs via pre-defined protocols (e.g., Application Programming Interface (API)).

The sector determination module 304 determines a target technology sector associated with the target patent asset. If a technology sector is already identified in the price request, the technology sector in the request can be used as the target technology sector. If a technology sector is not provided with the price request, the patent office classification code of the patent asset may be used as the target technology sector. The sector determination module 304 may also search the patent database 162 to identify other patents within the target technology sector.

The effective period module 306 determines an effective period of the target patent asset. The effective period represents the estimated lifecycle of products for which the patent is used and can be viewed as the period of time during which the target patent asset has value. In one embodiment, the effective period can be determined from a cited-by duration in the technology sector. For a given patent asset, the cited-by duration is the period of backward citations by other patent assets that refer back to that given patent asset. In specific, for each patent asset in a technology sector, citations back to the patent asset from other patent assets are collected. The backward citations may include citations from all patent assets from all technology sectors. The citations back to the patent asset are analyzed to determine when the citations stop. The amount of time between the filing/publication of the patent asset and the last forward citation represents the patent life cycle for the patent asset. For example, if a patent asset issues in 2000 and citations from other patents to the patent asset end in 2010, the patent asset has a 10 year effective period. The effective periods for the patent assets in the technology sector are averaged to produce a representative effective period for all patent assets in the technology sector, which is applied to the target patent asset.

The effective period is generally limited to the legally granted life of the target patent asset. For example, if the effective period is calculated to be 25 years from issuance, but patent assets in a country expire within 20 years, the effective period can be reduced to 20 years. This is because patent assets do not have value after they expire.

In one embodiment the effective period is a total effective period including portions of the effective period in the past, as well as portions of the effective period in the future. The total effective period can begin at the issuance of a patent and continue until the end of the effective period. The total effective period is useful when computing a price of a target patent asset that accounts for both past and future damages payable by potential infringers. The effective period can alternatively be restricted to only a forward looking effective period that only includes the portion of the effective period in the future. The forward looking effective period begins at the current time and ends at a future time.

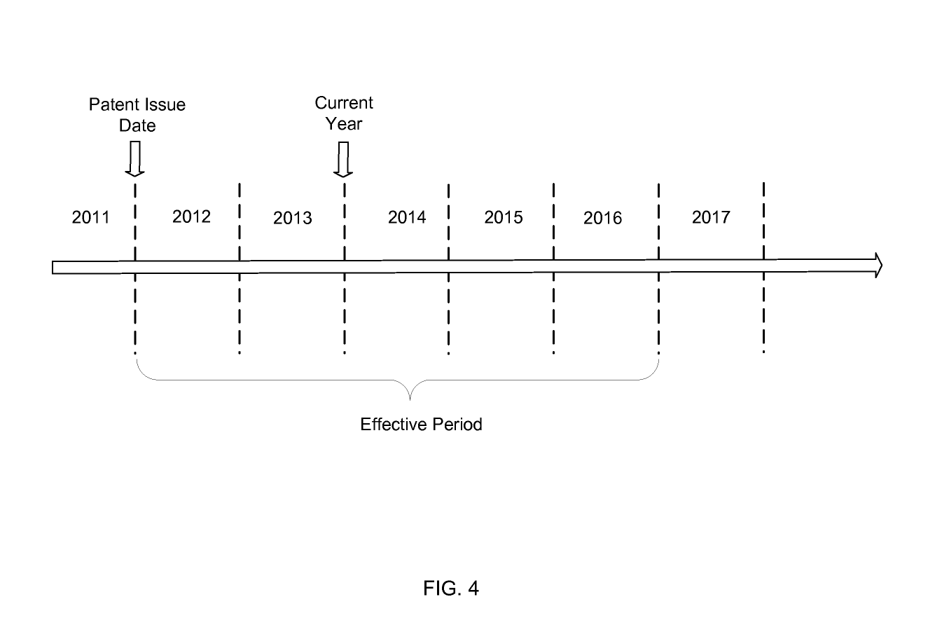

Referring to FIG. 4, illustrated is an effective period of a patent asset, according to an embodiment. The target patent asset issued at the beginning of the 2012. This target patent asset has an effective period that lasts for five years from 2012 until 2016. This five year effective period is a representative effective period determined from other patent assets in the same technology sector as the target patent asset. The client 110 has requested the price for the target patent asset at the beginning of the year 2014. A portion of the effective period that includes years 2012 and 2013 is in the past, whereas a portion of the effective period that includes years 2014, 2015 and 2016 are in the future.

Referring back to FIG. 3, the sector analysis module 308 determines a total profit for the target technology sector during the effective period. Profit is one example of a financial metric, and in other embodiments the sector analysis module 308 can estimate other financial metrics. In one embodiment, the sector analysis module 308 generates a query for the target technology sector and then searches the patent database 162 with the query to identify patent assets that are in the target technology sector for a target time frame. The sector analysis module 308 identifies companies that own the patent assets in the target technology sector. The sector analysis module 308 then searches the company database 164 for financial metrics of those companies, which it uses in determining the total profit for the technology sector as a whole. Several techniques may be used in estimating the total profit for the technology sector depending on the amount of financial information available in the corporate database 164 for the companies in the technology sector. In one embodiment the total profit is generated for a specific technology sector in a target country for a target time frame (e.g. year).

Sector analysis module 308 can determine both past total profit and future total profit for the target technology sector. Past total profit can be estimated from the financial information in the company database 164. Future total profit can be extrapolated from past overall profit using any appropriate statistical technique for estimating future profits from past profits (e.g., linear regression). Total profit can also be divided into discrete periods of time (e.g., annual profits) or calculated as a single lump sum, such as by calculating a single profit number that represents the total profit over the next five years.

Patent profit contribution module 310 determines the portion of the total profit in the target technology sector that is attributed to patents. Initially, the patent contribution module 310 calculates a patent contribution to business ratio (PCBR) metric. There may be many factors that contribute to market profit, such as sales, marketing and patents, and the PCBR metric represents the amount of contribution of patent assets to business success or profit within a technology sector.

In one embodiment PCBR is calculated with the following equation:

$$PCBR = \frac{RDExp}{OperatingExp}$$

RDexp is research and development (R&D) expenses associated with one or more companies in the technology sector. OperatingExp is total operating expenses associated with one or more companies in the technology sector and includes R&D expenses, cost of goods sold, selling expenses, etc. PCBR is thus the ratio of R&D expenses to all operating expenses and this ratio is used as a proxy for how much patents, which usually are a result of R&D, contribute to the business.

RDExp and OperatingExp can be calculated from financial information for all companies in the technology sector. Alternatively RDExp and OperatingExp can be calculated from financial information for only a single company that is representative of the technology sector. If a company operates in multiple technology sectors including the target technology sector, RDExp and OperatingExp may be the R&D and operating expenses for the company as a whole across all technology sectors for simplicity. RDExp and OperatingExp can also be calculated over a pre-determined period of time (e.g. 3 years). RDExp and OperatingExp are further examples of financial metrics and the process of determining these metrics may be similar to the process performed by the sector analysis module 308.

In another embodiment PCBR is calculated with the following equation:

$$PCBR = \frac{NumInventors}{NumEmployees}$$

NumInventors is the number of inventors associated with the target technology sector and may include the number of inventors in a single company in the technology sector or the number of inventors across all companies in the technology sector. NumEmployees is the number of employees associated with the target technology sector and may include the number of employees in a single company in the technology sector or the total number of employees across all companies in the technology sector. PCBR is thus the ratio of number of inventors in to number of employees and this ratio is used as a proxy for how much patents, which are filed by inventors, contribute to the business in the technology sector.

In one embodiment, the number of inventors is determined by counting the number of unique inventors from all of the patent assets in the technology sector during a pre-determined period of time. For example, the number of inventors can determined only from patent assets issued over the past three years. In other embodiments there may be other techniques for determining the number of inventors.

In one embodiment, the number of employees can be determined by identifying companies that are assignees of patent assets in the target technology sector, and then counting the number of people employed by those companies. The number of employees can be obtained from publicly available information in the company database 164.

Some companies may also operate in multiple technology sectors. To reduce the employee count to only those employees in the target technology sector, the following steps are performed: (1) the number of unique inventors for all patent assets of the company is determined, (2) the number of unique inventors for patent assets of the company within the technology sector is determined, (3) an inventor ratio is calculated by dividing (2) by (1), and (4) the inventor ratio is multiplied by the total number of employees of the company to obtain the number of employees within the technology sector. This technique assumes the portion of a company's inventors in the target technology sector are similar to the portion of the company's employees in the target technology sector. Further, for a company that operates in multiple technology sectors including the target technology sector, the number of inventors for patent assets and number of employees may be counted across the company as a whole across all technology sectors for simplicity.

The patent profit contribution module 310 then calculates the portion of the total profit in the technology sector attributed to patents with the following equation:

PatentAttributedprofit=PCBR×Totalprofit

Totalprofit is the total profit in the technology sector for a period of time.
PatentAttributedprofit is the portion of the total profit attributed to patents. The portion of the total profit attributed to patents is determined by multiplying PCBR by total profit in the technology sector.

The profits per patent score module 312 determines a profit per patent score (PPPS) metric. The PPPS is determined by searching the patent database 162 to identify all patent assets in the technology sector. Each patent asset has a patent score that is retrieved from the patent score database 172. The patent scores are summed together to determine a total patent score. The PPPS is then calculated with the following equation:

$$PPPS = \frac{PatentAttributedprofit}{TotalPatentScore}$$

TotalPatentScore is the sum of all the patent scores in the technology sector. PPPS is the profits per patent score and is calculated by dividing PatentAttributedprofit by the TotalPatentScore. PPPS thus represents the amount of profit attributed to a single patent score point. A single PPPS can be calculated to cover the entire effective period, or different PPPS numbers can be calculated for each discrete period of time (e.g. for each year) within the effective period.

The target patent profit module 314 determines profit attributed to the target patent asset by multiplying the patent score of the target patent asset by the PPPS. The patent score represents the objective rating of a patent asset. A patent asset with a higher patent score will have higher profit attributed to it than a patent asset with a lower patent score. A single profit number can be calculated for the entire effective period. Alternatively, different profits can be calculated for each discrete period of time (e.g. for each year) within the effective period using different PPPS numbers.

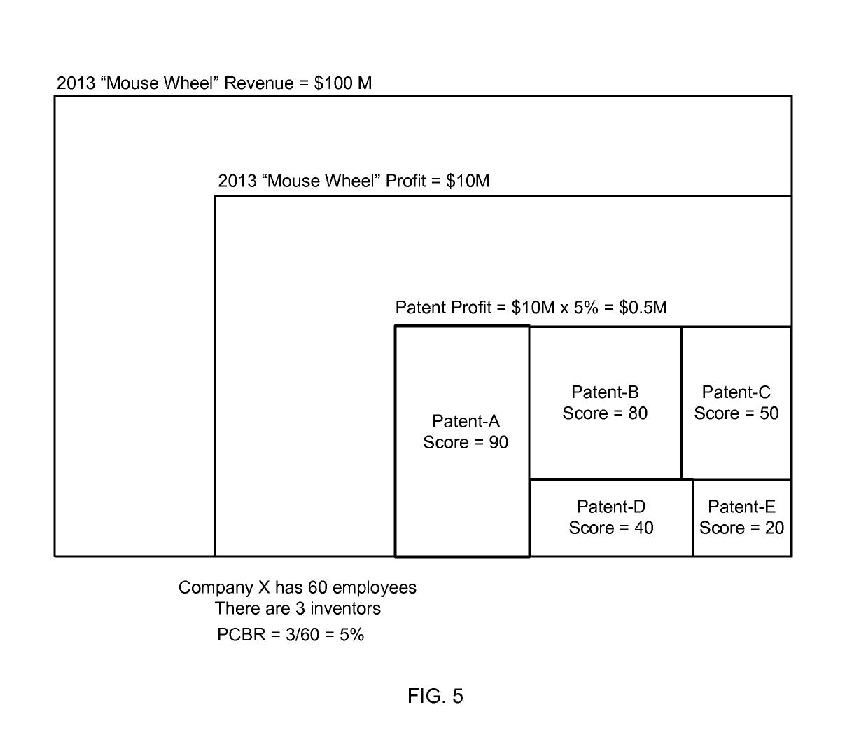

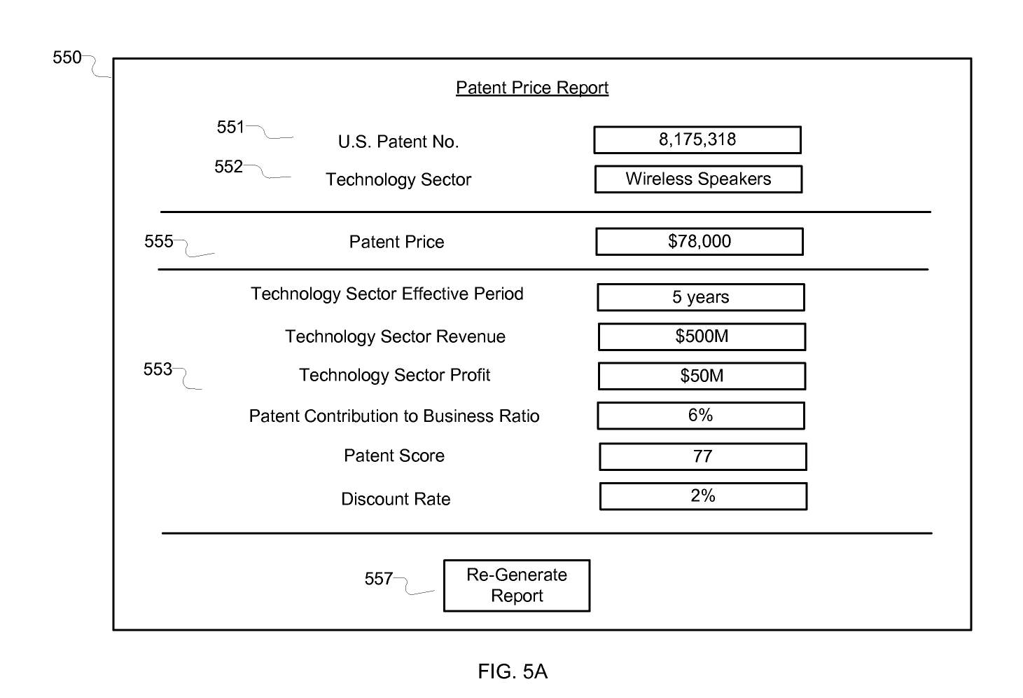

Referring to FIG. 5, illustrated is an example of computing a profit attributed to a patent for a single year, according to an embodiment. In FIG. 5, the profit is being calculated for patent asset “Patent-E” in the technology sector of “Mouse wheel.” There are a total of five patents in the mouse wheel technology sector: Patent-A, Patent-B, Patent-C, Patent-D and Patent-E. The total revenue of the mouse wheel technology sector is $100M. The total profit of the mouse wheel technology sector is $10M.

In this example, there is only one company in the mouse wheel technology sector, called company X. Company X has 60 employees. Three of those employees are the inventors of the five patents in the Mouse Wheel technology sector. Thus, the PCBR is equal to 3/60, which is 5%. Only one company is shown to simplify the example, but typically there may be a large number of companies in a technology sector and the employees across the companies are combined.

The profit attributed to all patents is computed by multiplying the PCBR by the total profit in the technology sector. Thus, the profit attributed to the five patents is equal to $10M×5%, which is $0.5M.

Patent-A has a patent score of 90. Patent-B has a patent score of 80. Patent-C has a patent score of 50. Patent-D has a patent score of 40. Patent-E has a patent score of 20. The total combined patent score for the five patents is 90+80+50+40+20, which is a patent score of 280. The PPPS is computed as the profit attributed to patents divided by the total combined patent score. Thus, the PPPS is $0.5M divided by 280, which is $1785.7 per patent score.

The profit attributed to Patent-E in 2013 is computed by multiplying the patent score of Patent-E by the PPPS. Thus, the profit attributed to Patent-E in 2013 is 20 multiplied by $1785.7, which is $35,714.

Referring back to FIG. 3, the pricing module 316 determines a price for the target patent asset from the profit determined by the target patent profit module 314. In one embodiment the profit determined by the target patent profit module 314 can be directly used as the price for the target patent asset. In another embodiment, if different profits for the target patent asset were determined for discrete time periods within the effective period, the profits can be combined to generate a price for the target patent asset. The pricing module 316 may also apply discounted cash flow valuation to the profits using a discount rate to generate a price that represents the present value of the profits.

The price information module 318 generates a patent price information output for the target patent asset from the price of the target patent asset. The patent price information output describes the value of the patent and can be sent out/transmitted via the communication module 302. In one embodiment the patent price information output may include the price of the target patent asset. In another embodiment the patent price information output is a price report on the target patent asset. The price report can include the patent price (e.g., $1M) or graphical information generated using the patent prices. The report may also include other information that is useful in understanding how the patent price was determined, such as the effective period, PCBR, patent score, the discount rate, profit numbers for each discrete period of time within the effective period, and other pertinent information. The report may also include revenue information for the technology sector.

In one embodiment the communication module 302 may also receive criteria values from the client 110 that are used during the process of generating the price information output. Criteria values can include values for overall profit of a technology sector, PCBR, effective period, patent score, discount rate, etc. These criteria values may have default values that are adjustable by a user of the client 110 via a user input. The criteria values provided by the user are then used in determining the profit and generating the price information output.

FIG. 5A illustrates a price report 550 generated by the price information module 318 and displayed at the client 110, according to an embodiment. The price report identifies a patent 551 requested by a client 110 for pricing and a technology sector 552 provided by the client 110. The report 550 also includes the estimated price 555 of the patent 551, which is determined by the price estimation module 170.

The price report 550 also includes values for different criteria 553 used during the generation of the price report 550. These criteria values 553 may be user adjustable. Initially the default values for the criteria 553 are determined automatically by the price estimation module 170. The user may then provide adjustments to the criteria values 553 and request that a report be re-generated 557 with the new criteria values 553. The price estimation module 170 receives the new criteria values from the client 110 and generates an updated report using the new criteria values 553.

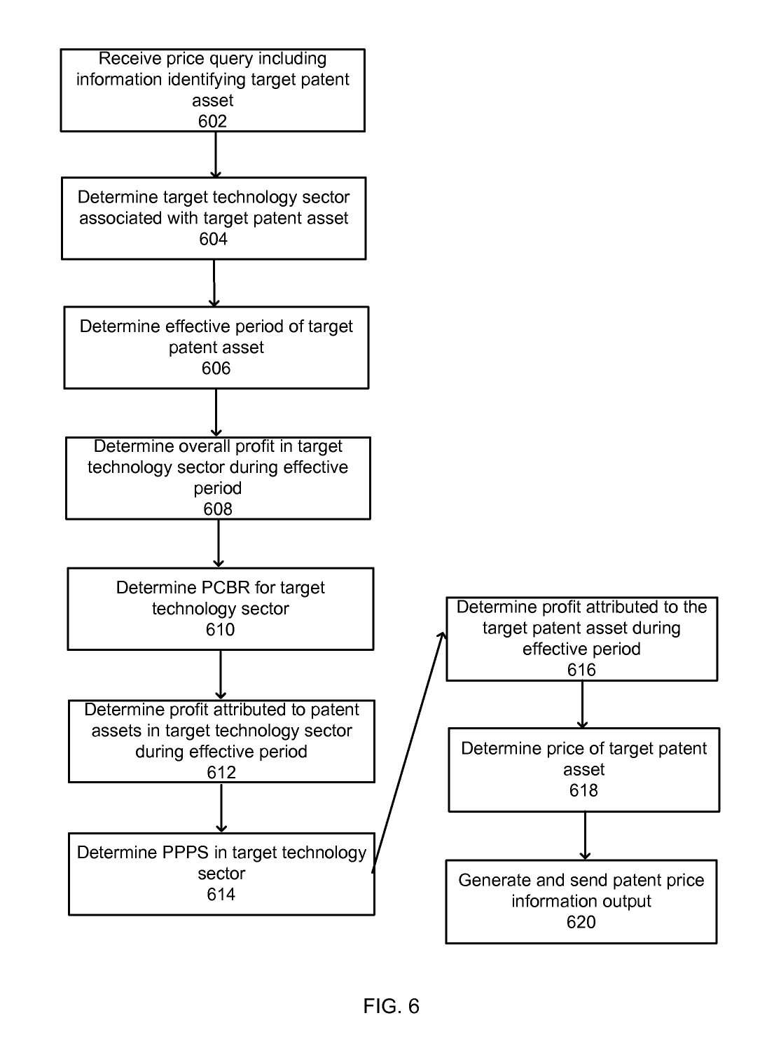

FIG. 6 illustrates a patent price estimation process performed by the price estimation module 170 of FIG. 1, according to an embodiment. In step 602, a price query is received that includes information identifying a target patent asset. The price query may also identify a target technology sector associated with the patent asset. In step 604, a target technology sector associated with the target patent asset is determined. In step 606, an effective period of the target patent asset in the target technology sector is determined.

In step 608, a total profit of the target technology sector during the effective period is determined. In step 610, a PCBR metric for the target technology sector is determined. In step 612, a profit attributed to patent assets in the target technology sector is determined using the PCBR and the total profit of the target technology sector. In step 614, the PPPS in the target technology sector is determined from the profit attributed to patent assets in the target technology sector and the total patent scores in the target technology sector.

In step 616, profit attributed to the target patent asset during the effective period is determined from the patent score of the target patent asset and the PPPS. In step 618 the price of the target patent asset is determined from the profit of the target patent asset. The price can be generated, for example, by combining profits for each year of the effective period and discounted the profits with a discount rate. In step 620, a patent price information output is generated from the patent price and the patent price information output is sent, for example, to the client 110.

In one embodiment the processes described herein are only applied to issued patents. In other embodiments, the processes may be applied to both issued patents and published patent publications, or only published patent applications. In one embodiment multiple patent assets may be evaluated at the same time and the prices for the patent assets may be combined into a single patent information output. In other embodiments the principles described herein can be applied to IP assets other than patents assets, such as copyrights and trademarks.

### Estimating Market Sector Size/Revenue/Profits

The sector analysis module 308 is now described in greater detail. The sector analysis module 308 uses patent assets in the target technology sector to estimate a total financial metric for the target technology sector across all of the companies in the technology sector. The financial metric can also be estimated over any fixed period of time, such as for a year, a half-year, a quarter-year, etc. Embodiments described below may focus primarily on revenue as a financial metric, but the sector analysis module 308 will also estimate profit as described above.

In specific, the sector analysis module 308 identifies companies that own the patents in the technology sector. The sector analysis module 308 then searches the company database 164 for financial metrics of those companies, which it uses in estimating the total financial metric for the technology sector as a whole. For some companies, the company database 164 may include exact financial metrics for the company that are divided into different technology sectors. However, for most companies the company database 164 only has generic financial metrics for the company as a whole that are not specific to any particular technology sector.

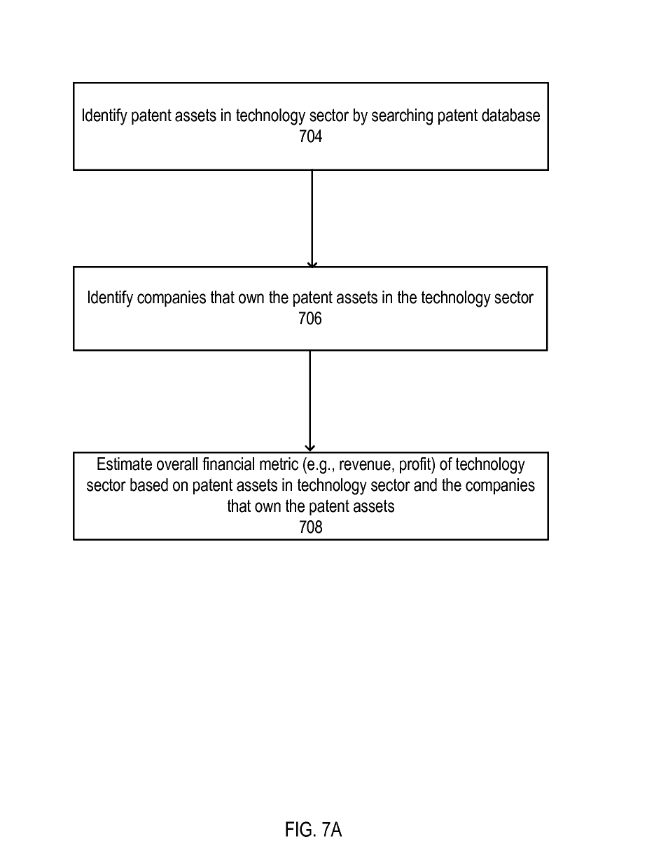

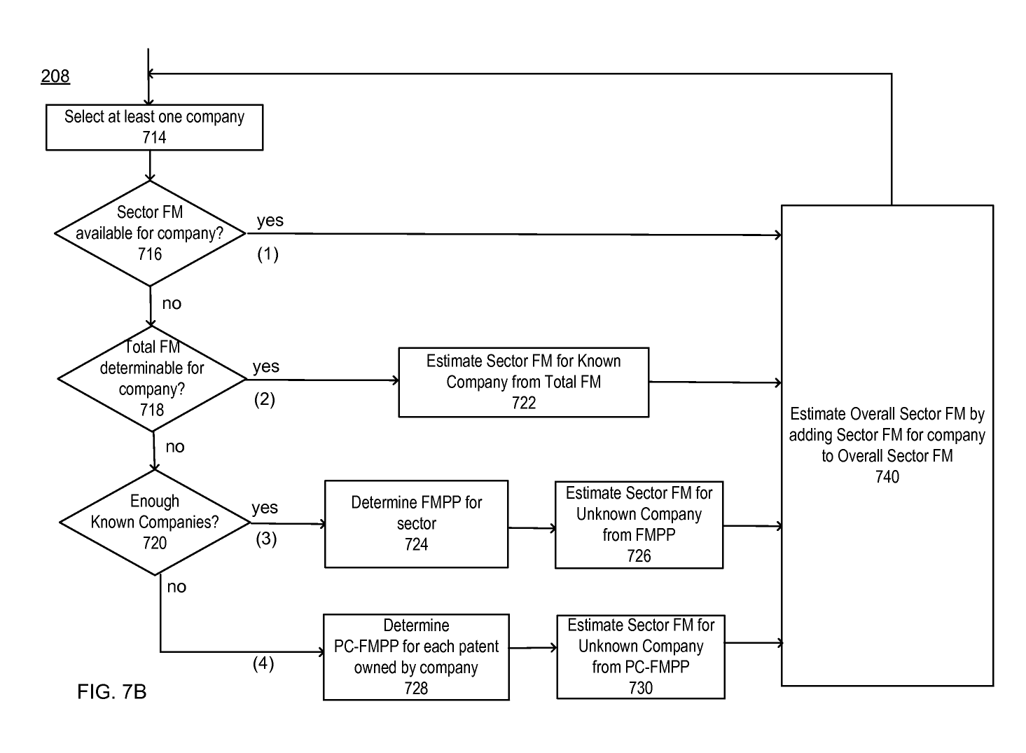

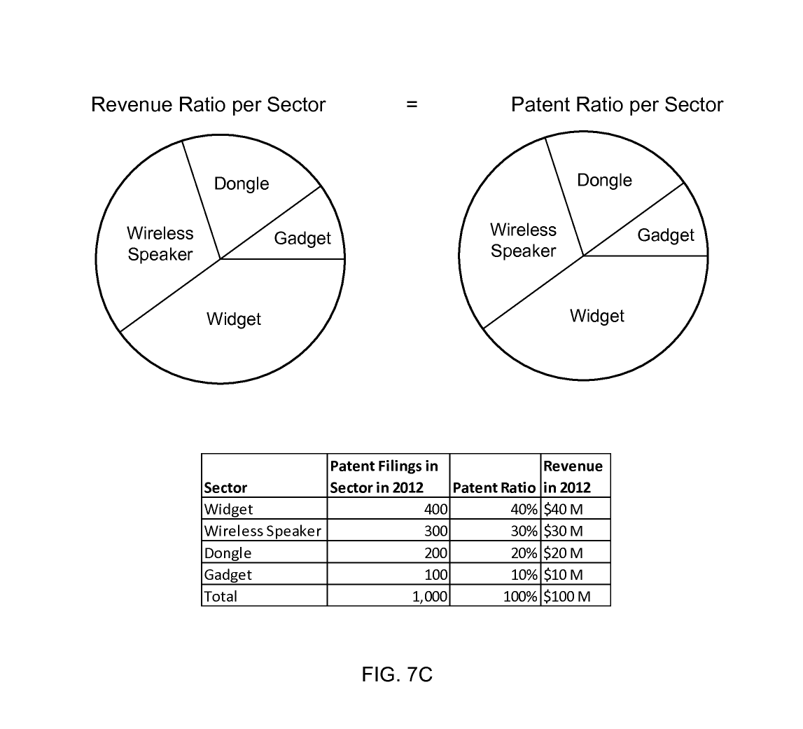

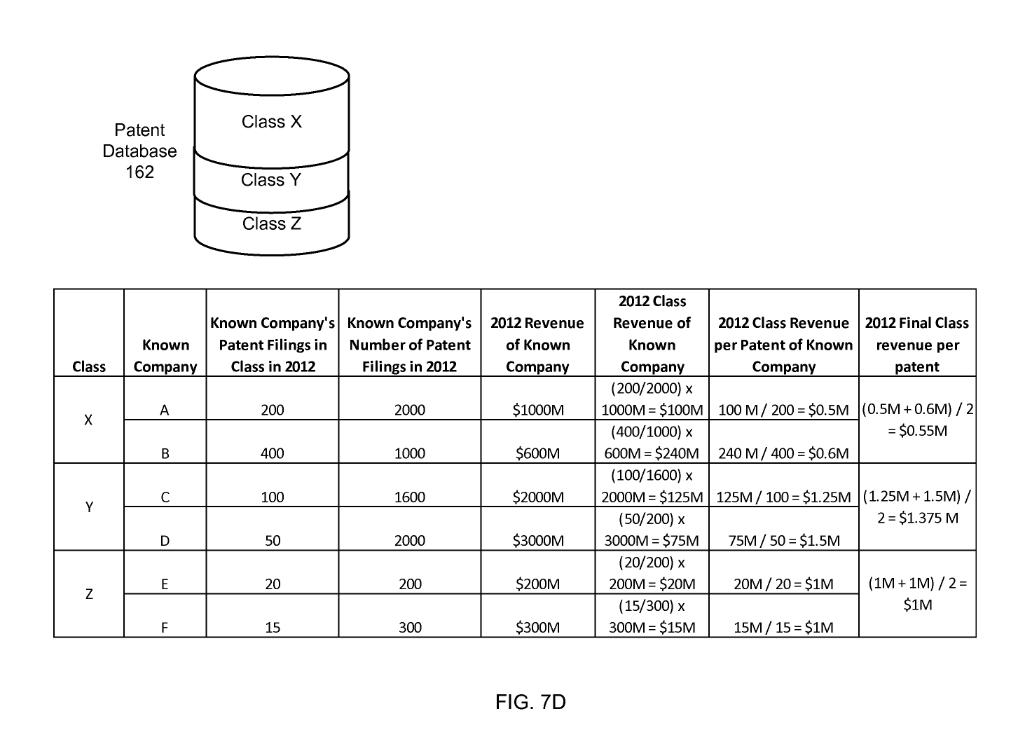

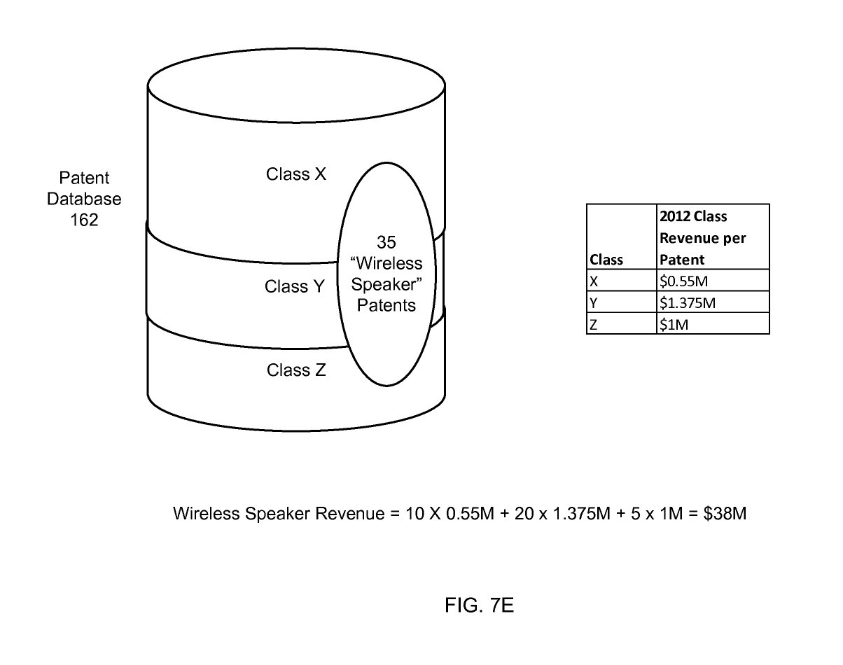

Several techniques may be used in estimating the total financial metric for the technology sector depending on the amount of financial information available in the company database 164 for the companies in the technology sector. In one embodiment the total financial metric is generated for a specific technology sector in a target country for a target time frame (e.g. year). These techniques will be explained in greater detail by reference to FIG. 7A through 7E.

Referring now to FIG. 7A, illustrated is a flowchart for a method for estimating market sizes of a technology sector, according to one embodiment. In one embodiment, the steps of FIG. 7A can be performed by sector analysis module 308.

In step 704, the sector analysis module 308 identifies patent assets in the target technology sector by searching the patent database 162. The patent database 162 is searched by generating a search query that is provided to the patent database 162. The search query may be formulated only to identify patent assets within a target time-frame and within a target country. For example, if the technology sector is “wireless speakers” the search query may be a Boolean search query such as “specification=wireless speakers AND filed=2012 AND country=US.” This search query searches for patents that include the text of wireless speakers, are first filed in 2012, and were filed in the United States. Another example of a search query is “specification=wireless speakers AND unexpired=2012 AND country=US.” This search query searches for patents that include the text of wireless speakers, are unexpired as of 2012, and were filed in the United States.

The patent database 162 returns a list of patents assets that match the search query. The matching can be performed with a text matching algorithm that searches the text of each patent asset to identify patent assets that exactly match the search query or are deemed to be sufficiently related to the search query. A number of different search algorithms can be used to identify a list of patent assets that best match the search query.

In one embodiment, the sector analysis module 308 identifies patent assets for a target time frame from patent assets having a filing date that falls within the target time frame. For example, if a financial metric is being generated for the year 2012, the sector analysis module 308 identifies patent assets that were filed in 2012 while excluding patent assets filed in other years. In another embodiment, the market estimation system 130 identifies patent assets that are enforceable during the target time frame. Patent assets are generally enforceable if they are issued as patents and have not yet expired or been terminated. In other embodiments different techniques may be used for identifying the patent assets for a target time frame, such as using earliest priority date or publication date to filter the patent assets. Additionally, the time frame for the identified patent assets may be the same as or different than the time frame for the market report. For example, the patent assets published in late 2013 and early 2014 can be combined with financial information from 2012 to estimate the financial metric for a technology sector in 2012. This is because publication typically lags filing by approximately 18 months.

In one embodiment, the sector analysis module 308 identifies one or more types of patent assets. For example, the market report can be generated from issued patents, patent publications, or both issued patents and patent publications.

In step 706, the sector analysis module 308 identifies companies that own the identified patent assets in the target technology sector. The companies can be identified by querying the patent database 162 for assignment and/or applicant information associated with the identified patent assets.

In step 708, the sector analysis module 308 estimates a total financial metric (e.g., revenue or profit) of the target technology sector for a target time frame based on the patent assets in the technology sector and the companies that own the patent assets. The sector analysis module 308 generally calculates a sector financial metric on a company by company basis, and then sums together the company specific sector financial metrics to generate a total financial metric for the entire technology sector across all companies. In one embodiment the financial metric is generated for a specific technology sector in a specific country in a particular year. Step 708 will be explained in greater detail by reference to FIG. 7B.

FIG. 7B is a flowchart for the step of estimating a financial metric of a technology sector from FIG. 7A in greater detail, according to an embodiment. The flowchart of FIG. 7B effectively illustrates four alternative techniques for estimating the total financial metric (e.g. total revenue or profit) of a technology sector across all companies in the sector. The four techniques may be combined or used individually to achieve an accurate estimate of the total financial metric for the technology sector, and are labeled with notations of (1) through (4) in FIG. 7B.

In step 714, the sector analysis module 308 selects one or more companies for analysis. In one embodiment, the patent assets in the target technology sector and financial metrics are analyzed on a company by company basis until all of the patent assets in the technology sector are accounted for.

In step 714, the sector analysis module 308 determines whether a sector specific financial metric (“Sector FM”) is available for the selected company in the company database 164 for a target time frame. The company database 164 is accessed to determine if Sector FM for the company is available in the company database 164 for the company. The most accurate way to estimate the Sector FM for a company is when the Sector FM is already known for a company. Thus, if the Sector FM for the company is available, in step 740, the total financial metric for the technology sector (“Overall Sector FM”) is estimated by adding the Sector FM for the company to the Overall Sector FM. However, the Sector FM is not likely to be available for most companies. If the Sector FM is not available for the company, the process proceeds to step 718.

In step 718, the sector analysis module 308 determines whether a total financial metric (“Total FM”) (e.g., total yearly U.S. revenue) can be estimated for the company for a target time frame in a target country using information in the company database 164. The Total FM represents the FM for a company attributed to all technology sectors and is not specific to a single technology sector. Companies for which the Total FM for a target time frame and target country can be determined are referred to herein as a “Known Company.”

In one embodiment, the company database 164 is accessed to determine if Total FM for the company is already available in the company database 164. In another embodiment, if Total FM for a company in a target country is not known, but the international FM for the company in all countries is known, the sector analysis module 308 can estimate the Total FM for the company in a target country from the country's total gross domestic product (GDP) and country's total exports. The Total FM can be estimated using the following formula:

$$TotalFM = InternationalFM \frac{GDP - ExportAmount}{GDP}$$

where TotalFM is the FM for a target company in a target country, InternationalFM is the FM for a target company across all countries, GDP is the gross domestic product of the target country, and ExportAmount is the amount of the target country's exports. This estimation assumes that a proportion of a company's FM attributed to exports is related to the proportion of a country's GDP attributed to exports.

If the Total FM can be determined for a company, in step 722, the sector analysis module 308 estimates the Sector FM for the Known Company from the Total FM with the following equation:

$$SectorFM = TotalFM \times \frac{NPSector}{NPTotal}$$

where NP Sector is the number of patent assets for the target time frame owned by the Known Company in the requested technology sector in a target country, and NP Total is the total number of patent assets for the target time frame owned by the Known Company regardless of and across all technology sectors in a target country. NP Sector can be determined by counting the number of patent assets owned by the Known Company in the technology sector that fall within the target time frame (e.g., patent assets filed in 2012, patent assets enforceable in 2012). NP Total can be determined by counting the total number of patent assets owned by the Known Company that fall within the target time frame (e.g. patent assets filed in 2012, patent assets enforceable in 2012). This calculation assumes the patent activity of a company for a specific technology sector is proportional to the financial metric of the company in that technology sector. Thus, the ratio of patent assets in the target technology sector can be used to estimate the financial metric (e.g. revenue) for that technology sector.

Referring briefly to FIG. 7C, illustrated is a technique for estimating revenue of a company in a technology sector when the total revenue of the company is known, according to an embodiment. In FIG. 7C, it is assumed that the financial metric of interest is revenue, the Known Company filed a total of 1,000 patent assets in 2012, and the Known Company has a revenue of $100 million in 2012. The Known Company sells products in four technology sectors of widget, wireless speaker, dongle, and gadget. The company filed 400 widget patents, 300 wireless speaker patents, 200 dongle patents, and 100 gadget patents in 2012. Because 40% of the company's patent filings are in widgets, the widget revenue of the Known Company is estimated to be $40 million for 2012, which is 40% of the Known Company's yearly revenue. Similarly, because 30% of the Known Company's patent filings are in wireless speakers, the wireless speaker revenue of the Known Company is estimated to be $30 million for 2012.

In other embodiments, the second column may be the enforceable patent assets in 2012 instead of patents filed in 2012. In this embodiment, there would be 400 widget patents, 300 wireless speaker patents, 200 dongle patents, and 100 gadget patents enforceable in 2012.

Referring back to FIG. 7B, the process of estimating Sector FM shown in step 722 is possible when the Total FM of a company is known. However, the Total FM for a company is not always available. For example, some companies are private companies that do not release any public financial data. If the Total FM for a company is not known (“Unknown Company”), it is not possible to estimate the Sector FM for the company using the technique in step 722. Thus, if the Total FM for a company is not known, the process proceeds to step 720.

In step 720, the sector analysis module 308 determines whether there are enough Known Companies in the target technology sector (e.g., other companies for which total revenue can be determined for a target time frame and target country). For example, the sector analysis module 728 can determine whether there are more than a threshold number of Known Companies. If so, in step 724, the sector analysis module 308 determines a representative financial metric of each patent asset in the technology sector from the Total FM of the Known Companies in the technology sector for the target time frame. This representative financial metric represents the financial contribution attributed to a patent and is referred to as a financial metric per patent (“FMPP”). The FMPP is calculated for a Known Company by dividing the Sector FM for the Known Company by the number of patent assets in the technology sector for the target time frame owned by the Known Company. The FMPP from different Known Companies is then combined using a statistical technique, such as by determining the average of the FMPPs or a median FMPP, to obtain a final FMPP for the technology sector.

For example, suppose that in 2012, Known Company A has revenue in the wireless speaker sector of $30 million and filed 300 patents assets for wireless speakers (or alternatively, had 300 enforceable patents for wireless speakers during 2012). The revenue per patent for Known Company A in the wireless speaker sector is thus $100,000 per patent. Known Company B has revenue in the wireless speaker sector of $20 million and filed 100 patent assets for wireless speakers in 2012. The revenue per patent for Known Company B is thus $200,000 per patent. The two numbers can be averaged to result in revenue per patent of $150,000 for the wireless speaker sector in 2012.

In step 726, the Sector FM for the Unknown Company is calculated by multiplying the FMPP for the technology sector and the number of patent assets owned by the Unknown Company in the technology sector for the target time frame. For example, if the FMPP estimated from Known Companies is $150,000 for the wireless speaker sector, and Unknown Company C filed 100 patent assets for wireless speakers in 2012, the Sector FM for Unknown Company C is estimated at $15 million.

Thus, when financial information for a company is not available, step 720 and step 724 uses known financial information about other companies in the technology sector to infer the Sector FM for the company. The process of estimating Sector FM shown in step 724 and 726 is only useful when there are a statistically significant number of Known Companies. However, there may be situations where there are no Known Companies or only a few Known Companies. In this situation, the FMPP calculated in step 724 will not be a meaningful number. Thus, if there are not enough Known Companies, the process proceeds to step 728.

In step 728, the sector analysis module 308 determines, for each patent asset owned by the company, a representative financial metric for the patent asset from the patent office classification for the patent. This representative financial metric is referred to as a patent office classification financial metric per patent (“PC-FMPP”). In one embodiment the PC-FMPP is pre-calculated and stored in in the sector analysis module 308, and the sector analysis module 308 determines the PC-FMPP by retrieving the pre-calculated PC-FMPP associated with each patent asset. In another embodiment, the PC-FMPP can be determined by calculating the PC-FMPP in real-time.

Referring to FIG. 7D, illustrated is a technique for estimating revenue per patent using patent office classifications, according to an embodiment. This example assumes that the financial metric of interest is revenue and all of the patents in the patent database 162 are classified into one of three patent office classes: X, Y or Z. For each classification, Known Companies that have patents in the classification for a target time frame are determined. For each Known Company, a number of patents owned by the Known Company in the class for a target time frame and the total number of patents owned by the Known Company for the target time frame are determined from the patent database 162. The revenue of the Known Company for the target time frame is determined from the company database 164. The class revenue of the Known Company is determined by multiplying the total revenue of the company by a ratio of patents in the class to total patents. The class revenue per patent of the Known Company is determined by dividing the class revenue by the number of patents in the class. The final class revenue per patent is then estimated by averaging the class revenue per patent across different Known Companies.

For example, Known Company A filed 2000 total patents assets in 2012, of which 200 are in class X (or alternatively, Known Company A owned 2000 enforceable patent assets in 2012). Known Company A also has $1000 million (“M”) or $1 billion in revenue during 2012. The class revenue of Known Company A in class X is calculated to be $100 million. The class revenue per patent of Known Company A in class X is calculated to be $0.5M. The same process is repeated for Known Company B to generate a class revenue per patent of $0.6M in class X. The two numbers are then averaged to produce a final class revenue per patent of $0.55M for class X for 2012. The same process is repeated for class Y and class Z to estimate a class revenue per patent of $1.375M for class Y and class revenue per patent of $1M for class Z.

Each patent in the patent database is assigned a PC-FMPP according to the classification of the patent. This process assumes that all patents in a given classification have a similar FM attributed to them regardless of who owns the patents, e.g. all patents in class X have the same revenue of $0.55 M attributed to them for 2012, regardless of the company that owns the patents. Determining the PC-FMPP of a patent from the patent office classification of a patent allows the FM attributed to a patent to be determined even if financial information of other companies in the same technology sector are not known. In one embodiment, if a patent belongs to multiple classes, the first class listed on the patent determines the PC-FMPP assigned to the patent. In another embodiment, if a patent belongs to multiple classes, the PC-FMPPs for the different classes may be averaged into an average PC-FMPP for the patent.

As another example, in FIG. 7D, the third column may be Known Company's enforceable patent assets in the class during 2012 instead of patent filings in the class during 2012. Additionally, the fourth column may be Known Company's enforceable patent assets in 2012 instead of Known Company's patent filings in 2012.

Referring back to FIG. 7B, in step 730, the Sector FM for the Unknown Company is estimated from the PC-FMPP numbers. For example, the PC-FMPP of each of the Unknown Company's patents in the sector can be summed together to calculate the Sector FM. The Sector FM of a company is thus estimated even if financial information about the company or financial information about other companies in the same technology sector is not available for the target time frame.

Referring to FIG. 7E, illustrated is a technique for estimating a revenue of a company in a technology sector using revenue per patent that is pre-calculated based on patent office classifications, according to an embodiment. This example builds on the example of FIG. 7D and assumes that all patents fall into one of three classifications: X, Y and Z. The 2012 class revenue per patent is $0.55M for class X, $1.375M for class Y, and $1M for class Z as pre-calculated in FIG. 5A. The requested technology sector is “wireless speakers.” There are 35 patent assets in the technology sector of wireless speaker for this Unknown Company for 2012: 10 class X patent assets, 20 class Y patent assets, and 5 class Z patent assets. Thus, the revenue in the wireless speaker sector for this company is $38M (10×0.55M+20×1.375M+5×1M=$38M) in the year 2012.

Referring back to FIG. 7B, in step 740, the Overall Sector FM is estimated by adding the Sector FM for the company to the Overall Sector FM. Regardless of whether technique (1), (2), (3) or (4) is used to estimate the Sector FM for a company, the result is added to the Overall Sector FM to increase the Overall Sector FM. The steps in FIG. 7B are repeated until all of the patents in the requested technology sector and companies that own those patents are processed.

FIG. 7B thus presents four alternative techniques for determining a financial metric (e.g., revenue) of a technology sector. The techniques may be combined as needed to generate the financial metric, depending on the amount of financial information that is available in the company database 164. Technique (1) obtains a known Sector FM for a company when it is available, and likely produces the most accurate Sector FM. Technique (2) estimates the Sector FM when the Sector FM is not known, but financial information for the company is available. Technique (3) estimates the Sector FM when financial information for the company is not available, but financial information for other companies in the technology sector is available. Finally, technique (4) estimates the sector FM when there is limited financial information about any company in the technology sector. Techniques (3) and (4) may also be utilized when the company that owns a patent is not known.

### Example Computer Architecture

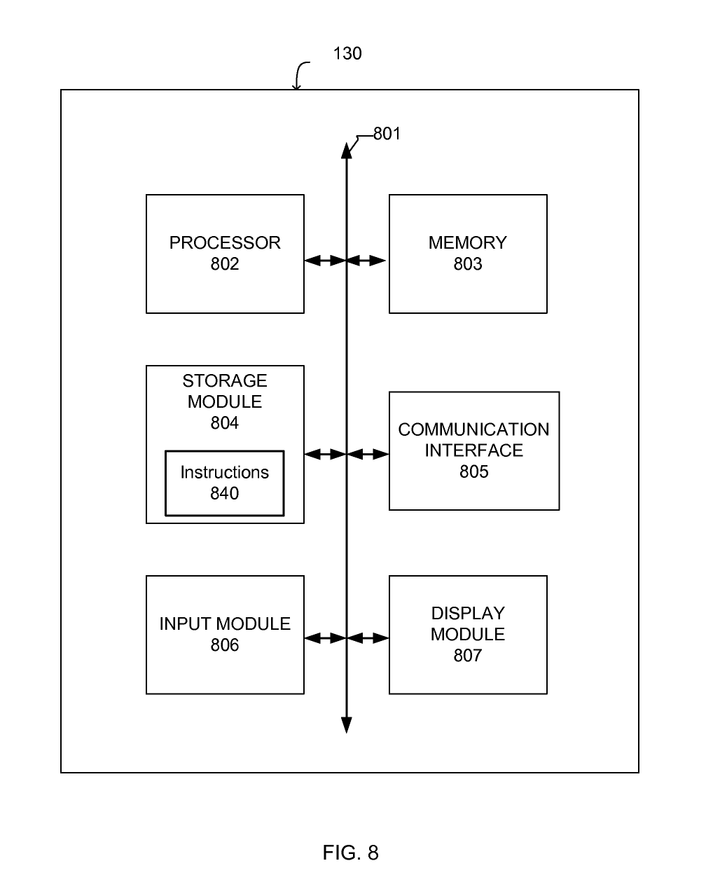

FIG. 8 illustrates the hardware architecture of a patent price estimation system 130 or client 110, according to one embodiment. In one embodiment, the patent price estimation system 130 is a server computer including components such as a processor 802, a memory 803, a storage module 804, an input module (e.g., keyboard, mouse, and the like) 806, a display module 807 and a communication interface 805, exchanging data and control signals with one another through a bus 801. The storage module 804 is implemented as one or more non-transitory computer readable storage media (e.g., hard disk drive), and stores software instructions 840 that are executed by the processor 802 in conjunction with the memory 803 to implement the market analysis described herein. For example, the storage module 804 may include software instructions 840 in the form of the price estimation module 170. Operating system software and other application software may also be stored in the storage module 804 to run on the processor 602.

Upon reading this disclosure, those of skill in the art will appreciate still additional alternative designs for a patent valuation system. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A computer-implemented method for patent valuation, comprising:
receiving, from a client device, information identifying a target patent asset;
determining a profit for a technology sector associated with the target patent asset;
determining a patent contribution metric corresponding to a contribution of patent assets to business in the technology sector;
determining a price for the target patent asset based on the profit for the technology sector and the patent contribution metric; and
generating a patent price information output for the client device based on the price for the target patent asset.

2. The method of claim 1, further comprising:
determining an effective period for the target patent asset, the effective period corresponding to a period of time during which the target patent asset has value,
wherein determining the profit for the technology sector comprises determining the profit for the technology sector associated with the target patent asset in the effective period.

3. The method of claim 2, wherein determining the effective period comprises:
determining the effective period for the target patent asset based on backwards citations to at least one or more patent assets in the technology sector associated with the target patent asset.

4. The method of claim 1, wherein determining the profit for the technology sector comprises querying a patent database for patent assets in the technology sector and determining the profit for the technology sector based on the patent assets in the technology sector.

5. The method of claim 1, further comprising:
determining a profit attributed to patent assets in the technology sector based on the profit for the technology sector and the patent contribution metric;
determining a profit per patent score (PPPS) based on patent scores of the patent assets in the technology sector and the profit attributed to the patent assets, the patent scores indicative of objective ratings of the patent assets; and
determining profit attributed to the target patent asset based on a patent score of the target patent asset and the PPPS,
wherein the price for the target patent asset is determined based on the profit attributed to the target patent asset.

6. The method of claim 1, wherein determining the patent contribution metric comprises determining the patent contribution metric based on research and development expenses in the technology sector and operating expenses in the technology sector.

7. The method of claim 6, wherein determining the patent contribution metric comprises determining the patent contribution metric based on a ratio of the research and development expenses to the operating expenses.

8. The method of claim 1, wherein determining the patent contribution metric comprises determining the patent contribution metric based on research and development expenses and operating expenses of at least one company, the at least one company associated with the technology sector.

9. The method of claim 1, wherein determining the patent contribution metric comprises determining the patent contribution metric based on a number of employees in the technology sector and a number of inventors for patent assets in with the technology sector.

10. The method of claim 9 wherein determining the patent contribution metric comprises determining the patent contribution metric based on a ratio of the number of inventors to the number of employees.

11. The method of claim 1, wherein determining the patent contribution metric comprises determining the patent contribution metric based on a number of employees of at least one company and a number of inventors of patent assets of at least one company, the at least one company associated with the technology sector.

12. A system for patent valuation, comprising:
at least one processor; and
at least one non-transitory computer readable medium storing instructions that are executed by the at least one processor for;
receiving, from a client device, information identifying a target patent asset;
determining a profit for a technology sector associated with the target patent asset;
determining a patent contribution metric corresponding to a contribution of patent assets to business in the technology sector;
determining a price for the target patent asset based on the profit for the technology sector and the patent contribution metric; and
generating a patent price information output for the client device based on the price for the target patent asset.

13. The system of claim 12, the instructions further comprising instructions for:
determining an effective period for the target patent asset, the effective period corresponding to a period of time during which the target patent asset has value,
wherein determining the profit for the technology sector comprises determining the profit for the technology sector associated with the target patent asset in the effective period.

14. The system of claim 13, wherein determining the effective period comprises:
determining the effective period for the target patent asset based on backwards citations to at least one or more patent assets in the technology sector associated with the target patent asset.

15. The system of claim 12, wherein determining the profit for the technology sector comprises querying a patent database for patent assets in the technology sector and determining the profit for the technology sector based on the patent assets in the technology sector.

16. The system of claim 12, the instructions further comprising instructions for:
determining a profit attributed to patent assets in the technology sector based on the profit for the technology sector and the patent contribution metric;
determining a profit per patent score (PPPS) based on patent scores of the patent assets in the technology sector and the profit attributed to the patent assets, the patent scores indicative of objective ratings of the patent assets; and
determining profit attributed to the target patent asset based on a patent score of the target patent asset and the PPPS,
wherein the price for the target patent asset is determined based on the profit attributed to the target patent asset.

17. The system of claim 12, wherein determining the patent contribution metric comprises determining the patent contribution metric based on research and development expenses in the technology sector and operating expenses in the technology sector.

18. The system of claim 12, wherein determining the patent contribution metric comprises determining the patent contribution metric based on research and development expenses and operating expenses of at least one company, the at least one company associated with the technology sector.

19. The system of claim 12, wherein determining the patent contribution metric comprises determining the patent contribution metric based on a number of employees in the technology sector and a number of inventors for patent assets in with the technology sector.

20. The system of claim 12, wherein determining the patent contribution metric comprises determining the patent contribution metric based on a number of employees of at least one company and a number of inventors of patent assets of at least one company, the at least one company associated with the technology sector.
